(19) United States
(12) Patent Application Publication
(10) Pub. No.: US 2007/0091729 A1
(43) Pub. Date: Apr. 26, 2007

(54) Regulator pin structure and regulator with the same, structure of balance with hairspring, and mechanical timepiece

(76) Inventor: Takashi Takahashi, Chiba-shi (JP)

Correspondence Address: BRUCE L. ADAMS, ESQ.;SUITE 1231, 17 BATTERY PLACE, NEW YORK, NY, 10004, US

(21) Appl. No.: 11/583,180

(22) Filed: Oct. 19, 2006

(30) Foreign Application Priority Data
Oct. 24, 2005 (JP) 2005-308719

(51) Int. Cl. G04B 17/20; G04B 17/04

(52) U.S. Cl. 368/170; 368/175

(57) ABSTRACT

There is provided a regulator pin structure that is not only easily assembled but also capable of holding a hairspring in a gap without a risk of the hairspring being released, a regulator with the regulator pin structure, a structure of balance with hairspring, and a mechanical timepiece. A regulator pin structure of a regulator that is a component of a structure of balance with hairspring of a mechanical timepiece includes a pin-like body, a base that is situated on one end of the body and mounted to a body of regulator such that the position of the base is adjustable around the pivotal center axis E of the body, and a pair of two-pronged legs that extend from the other end of the body. The regulator pin structure is configured such that part of the outer end of a hairspring that is situated beyond a reformed portion of the hairspring along the outer circumference direction is freely fitted in a gap between the legs. Canopy-like projections are formed on at least one side edge of the front portion of at least one of the pair of legs in such a manner that the canopy-like projections laterally project along sides of the legs that face toward the gap. Regulator pin structure and regulator with the same, structure of balance with hairspring, and mechanical timepiece

### BACKGROUND OF THE INVENTION

1. Field of the Invention

The present invention relates to a regulator pin structure and a regulator with the same, a structure of balance with hairspring, and a mechanical timepiece.

2. Description of the Prior Art

A regulator with “a regulator pin structure including a pin-like body, a base that is situated on one end of the body and mounted to a body of regulator such that the position of the base is adjustable around the pivotal center axis of the body, and a pair of two-pronged legs that extend from the other end of the body, the regulator pin structure being configured such that part of the outer end of a hairspring that is situated beyond a reformed portion of the hairspring along the outer circumference direction is freely fitted in a gap (slit) between the pair of legs” is well known and has been conventionally used for numerous mechanical timepieces.

While this regulator pin structure has an advantage that its structure is simplified because it does not need a regulator key, the outer end of the hairspring may be released from the gap between the legs when the regulator pin structure has experienced a strong shock.

To overcome this problem, it has been proposed that the tips of the legs are hammered to bend them inward, or in the direction in which the gap is narrowed (see the U.S. Pat. No. 4,083,179).

However, since this proposed regulator pin structure (although it is described (termed) as a “regulator key” in the U.S. Pat. No. 4,083,179, it is herein referred to as a regulator pin structure) is configured such that the tips of the pair of legs are bent inward to be closer to each other, when the gap between the tips is narrowed in order to prevent the outer end of the hairspring from being released, it is required to open the gap between the tips of the legs and forcibly push the hairspring therein for assembling, resulting in a cumbersome assembling process and also a potential accidental deformation of the hairspring.

Also, in this proposed regulator pin structure, since the tips of the legs are hammered to bend-them inward, not only may the legs of the regulator pin structure be deformed to a certain extent when they undergo the bending process so that the deformation may affect the behavior of the hairspring in a measurable manner but also variation among individual regulator pin structures may be large, resulting in potential cumbersome adjustment work. Also, it is difficult to automatically carry out this bending process without a dedicated processing machine and practically difficult to manufacture the regulator pin structure with a continuous processing system using a general purpose numerically-controlled machining tool.

Furthermore, since this proposed regulator pin structure. undergoes the inward bending process, the gap between the legs needs to be large enough or the tips of the legs needs to be thin enough to reliably carry out the inward bending process.

The invention has been made in view of the above circumstances and aims to provide a regulator pin structure that is not only easily assembled but also capable of holding a hairspring in a gap without a risk of the hairspring being released, a regulator with the same, a structure of balance with hairspring, and a mechanical timepiece.

### SUMMARY OF THE INVENTION

To achieve the above object, a regulator pin structure according to the invention includes a pin-like body, a base that is situated on one end of the body and mounted to a body of regulator such that the position of the base is adjustable around the pivotal center axis of the body, and a pair of two-pronged legs that extend from the other end of the body. The regulator pin structure is configured such that part of the outer end of a hairspring that is situated beyond a reformed portion of the hairspring along the outer circumference direction is freely fitted in a gap between the pair of legs. A canopy-like projection is formed on at least one side edge of the front portion of at least one of the pair of legs in such a manner that the canopy-like projection laterally projects along a side of the at least one leg that faces toward the gap.

In the regulator pin structure of the invention, since “the canopy-like projection is formed on at least one side edge of the front portion of at least one of the pair of two-pronged legs that extend from the other end of the pin-like body (the front-side end) in such a manner that the canopy-like projection laterally projects along the side of the at least one leg that faces toward the gap,” simply by freely fitting part of the outer end of the hairspring that is situated beyond the reformed portion of the hairspring along the outer circumference direction in the gap between the pair of legs of the regulator pin structure and pivoting the regulator pin structure around its center axis relative to the freely fitted portion of the outer end by a desired angle (hereinafter referred to as “predetermined pivotal movement”), the canopy-like projection is moved to a position on the front opening side of the gap, or behind the part of the outer end of the hairspring, where the canopy-like projection prevents a portion adjacent to the outer end of the hairspring from moving in a direction in which it is released.

The predetermined pivotal movement of the regulator pin structure is an adjustment procedure that is essential to adjust the effective width of the gap between the legs of the regulator pin structure in which the outer end of the hairspring is freely fitted in order to adjust the tilt width of the hairspring in a desired range. For example, by freely fitting the outer end of the hairspring with a thickness of about 0.03 mm in the gap with a width of about 0.09 mm and then pivoting the regulator pin structure, the effective width of the gap is reduced. The above dimensions are by way of example only. The magnitude of the predetermined pivotal movement is selected such that the width of the gap becomes a predetermined value. In the gap with a size defined by this predetermined width, the behavior of the outer end of the hairspring and hence the behavior of the entire hairspring is defined. That is, in the regulator pin structure of the invention, the pivotal adjustment of the tilt width of the hairspring allows the canopy-like projection to be positioned such that it serves to prevent the outer end of the hairspring from being released.

That is, in the regulator pin structure of the invention, as the distance between the legs including canopy-like projections can be sufficiently larger than the thickness of the outer circumferential portion of the hairspring, the hairspring is freely fitted between the legs of the regulator pin structure without difficulty and subsequent adjustment of the angle of pivotal movement of the regulator pin structure can set a structure of balance with hairspring.

In the above description, the body of the regulator pin structure may be long or short as long as it can join the base, which allows the structure to be mounted to the body of regulator, to the pair of legs. In some cases, the gap between the legs may extend into the body. In this case, the base-side portion of the legs may be considered as the body.

In the regulator pin structure of the invention, a side edge of at least one of the pair of legs is typically cut out and shaped such that the at least one leg has a thinner shape at a location closer to the other one of the pair of legs.

In this case, the angle of pivotal movement of the regulator pin structure can be large in order to adjust the effective width of the gap between the legs in which the outer end of the hairspring is freely fitted, allowing adjustment of the effective width to be easily carried out. Additionally, simply by providing a long canopy-like projection, the canopy-like projection can reliably prevents the hairspring from being released from the front opening of the gap. The cutout and the canopy-like projection may be simultaneously formed if the end of the cutout on the front side of the leg defines the surface of the canopy-like projection that faces toward the side of the hairspring. From this point of view, in the regulator pin structure of the invention, the cutout is formed such that a canopy-like projection is left at the front portion of the leg, instead of forming a cutout throughout the length of the front portion of the leg.

The regulator pin structure of the invention typically made of metal material. In the regulator pin structure of the invention, the canopy-like projection is typically formed by wiper cutting of the leg. That is, the cutout and canopy-like projection are formed by wiper cutting. In this case, the regulator pin structure can be formed by a series of continuous cutting operations, allowing its volume production to be easily carried out. However, if desired, the regulator pin structure with legs, cutouts and canopy-like projections may be formed by molding or other forming methods. The material of the regulator pin structure may be ceramic material, or in some cases, resin or other materials, if desired.

In the regulator pin structure of the invention, the edge of the projecting portion of the canopy-like projection is typically an extension of the outer circumferential surface of the body. This allows the canopy-like projection to be formed simply by cutting out the side edge of the leg of the regulator pin structure. If the body is tapered, the projecting portion of the canopy-like projection is smaller than the leg portion of the body. On the other hand, if the body becomes larger toward the end, the projecting portion of the canopy-like projection is larger than the leg portion of the body. However, if desired, the outer circumference of the canopy-like projection may project from the extension of the outer circumferential surface of the body, or may be recessed from the extension of the outer circumferential surface of the body.

In the regulator pin structure of the invention, a side; of the canopy-like projection of the at least one leg, the side being situated along the side of the at least one leg, is typically flush with the side of the at least one leg. This may ensure, as described above, easy free fitting of the hairspring in the gap between the legs of the regulator pin structure. However, if the canopy-like projection laterally projects by a sufficient amount, the side of the canopy-like projection may be recessed to some extent from the side of the leg. If desired, the side of the canopy-like projection may project to some extent from the side of the leg.

In the regulator pin structure of the invention, the canopy-like projection is typically formed on both side edges of the front portions of the both legs. This allows the canopy-like projections to prevent the hairspring from being released independent of the direction in which the regulator pin is pivoted and independent of the direction in which the spiral of the hairspring is wound.

When one of the side edges of one of the pair of legs has a canopy-like projection, to cooperate with this canopy-like projection, the opposite side edge of the other leg may have a canopy-like projection. Of course, as a minimum requirement, one of the side edges of one of the pair of legs may have a canopy-like projection. However, when a recessed cutout is formed by a cutting operation, such as wiper cutting, to form a canopy-like projection as a wall of the recessed portion, considering an easier cutting operation, the canopy-like projection is preferably formed on both side edges of the front portions of the both legs.

Therefore, in the regulator pin structure of the invention, as described above, the canopy-like projection is typically formed by wiper cutting. Also, in the regulator pin structure of the invention, canopy-like projections at the same side edge of the both legs typically have the same size and shape (mirror symmetry). However, if desired, the left and right canopy-like projections may have asymmetric shapes. In this case, the boundary between the canopy-like projection and the leg is inclined to the side of the leg that faces toward the gap between the legs. Therefore, when the regulator pin structure is pivoted such that the outer end of the hairspring extends diagonally with respect to the gap, such a canopy-like projection easily prevent the hairspring from being released from the front opening of the gap in a reliable manner.

In the regulator pin structure of the invention, the canopy-like projection is typically formed at both side edges of the front portions of the both legs, and a side of each of the canopy-like projections of each of the legs, the side being situated along the side of the leg, is flush with the side of the leg.

A regulator of the invention includes a body of regulator with a mounting hole for a regulator pin structure and a regulator pin structure like the one described above with a base mounted in the mounting hole of the body of regulator. The regulator is assembled to form a structure of balance with hairspring of the invention and the structure of balance with hairspring is assembled to form a mechanical timepiece of the invention.

The structure of balance with hairspring of the invention is configured such that, when the regulator pin structure is pivoted around its center axis, the canopy-like projection prevents the hairspring from being released from the gap.

### BRIEF DESCRIPTION OF THE SEVERAL VIEWS OF THE DRAWINGS

A preferred form of the present invention is illustrated in the accompanying drawings in which:

FIG. 1 is a descriptive plan view of a mechanical timepiece having a structure of balance with hairspring with a regulator pin structure of a preferred example according to the invention;

FIG. 2 is a descriptive plan view of a structure of balance with hairspring of the mechanical timepiece of FIG. 1;

FIG. 3 is a descriptive bottom (rear plan) view of the structure of balance with hairspring of FIG. 2;

FIG. 4 is a descriptive cross-sectional view of the structure of balance with hairspring of FIG. 2 taken along the line IV-IV (when the regulator pin structure is in a pre-pivotal movement position);

FIGS. 5 are series of views for explaining the operation of the regulator pin structure of the structure of balance with hairspring of FIG. 2; FIG. 5A is a descriptive, enlarged rear plan view of the part of FIG. 3 that is close to the regulator pin structure; FIG. 5B is a descriptive partial view of FIG. 5A showing the relationship between the regulator pin structure and the freely fitted portion of the outer end and its adjacent portions of the hairspring when the balance wheel is pivoted in a direction in which the hairspring is wound; and FIG. 5C is a descriptive partial view of FIG. 5A showing the relationship between the regulator pin structure and the freely fitted portion of the outer end and its adjacent portions of the hairspring when the balance wheel is pivoted in a direction in which the hairspring is unfolded (spread out);

FIG. 6 is a cross-sectional view taken along the line VI-VI shown in FIG. 4 for explaining the operation of the regulator pin of the structure of balance with hairspring of FIG. 2 and hairspring anti-releasing capability (after the regulator pin structure is pivoted to a predetermined position);

FIGS. 7 are series of views showing a regulator pin structure of a preferred example according to the invention that is used in the structure of balance with hairspring of FIG. 2; FIG. 7A is a descriptive front view; FIG. 7B is a descriptive bottom (rear plan) view; FIG. 7C is a descriptive cross-sectional view taken along the line VIIC-VIIC shown in FIG. 7A; and FIG. 7D is a descriptive perspective view of the regulator pin structure of FIG. 7A; and

FIGS. 8 are series of cross-sectional views similar to FIG. 7C for several variations of a regulator pin structure; FIG. 8A is a descriptive cross-sectional view showing an example with flat sides; FIG. 8B is a descriptive cross-sectional view showing an example with asymmetric projecting portions; FIG. 8C is a descriptive cross-sectional view showing an example with convex slit-defining sides; FIG. 8D is a descriptive cross-sectional view showing an example with convex and concave slit-defining sides; and FIG. 8E is a descriptive cross-sectional view showing an example with a projecting portion only on one side of each leg.

### DETAILED DESCRIPTION OF THE PREFERRED EMBODIMENTS

A preferred embodiment of the invention will be described with reference to a preferred example shown in accompanied drawings.

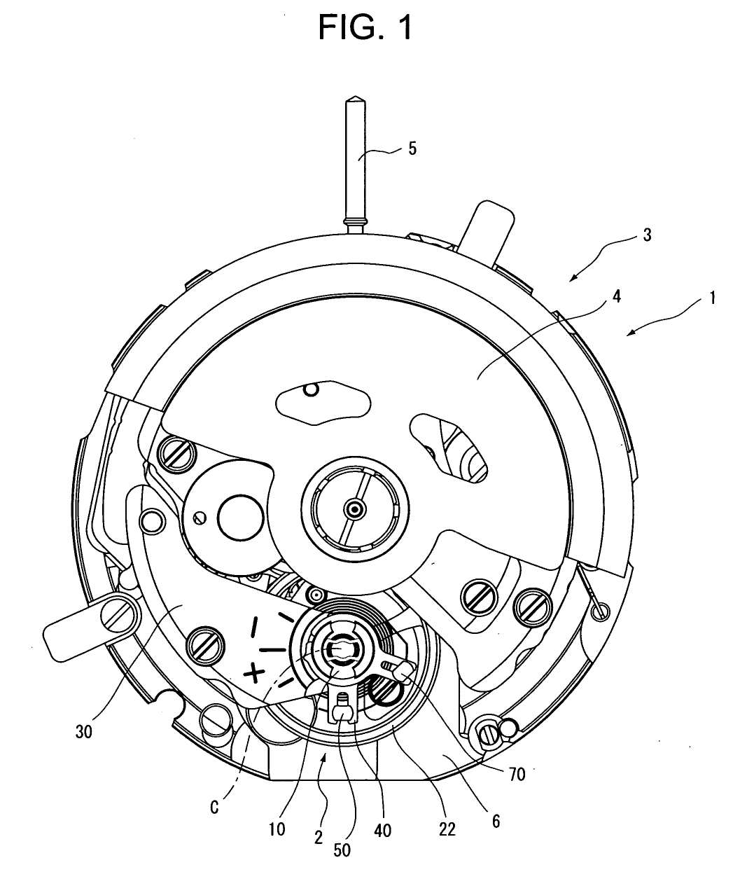

FIG. 1 shows a mechanical timepiece 1 of a preferred example according to the invention. In FIG. 1, only the mechanical timepiece 1 without the exterior, that is, a movement 3 is shown. The movement 3 of the timepiece 1 includes a structure of balance with hairspring 2 as a speed governor. Although the movement 3 of the timepiece 1 shown in FIG. 1 is a movement with an oscillating weight 4 for a self-winding timepiece, the movement 3 may be a manual-winding movement with a winding stem 5. The movement 3 of the mechanical timepiece 1 shown in FIG. 1 is by way of example only, and the detailed structure of the movement 3 may be any other structures.

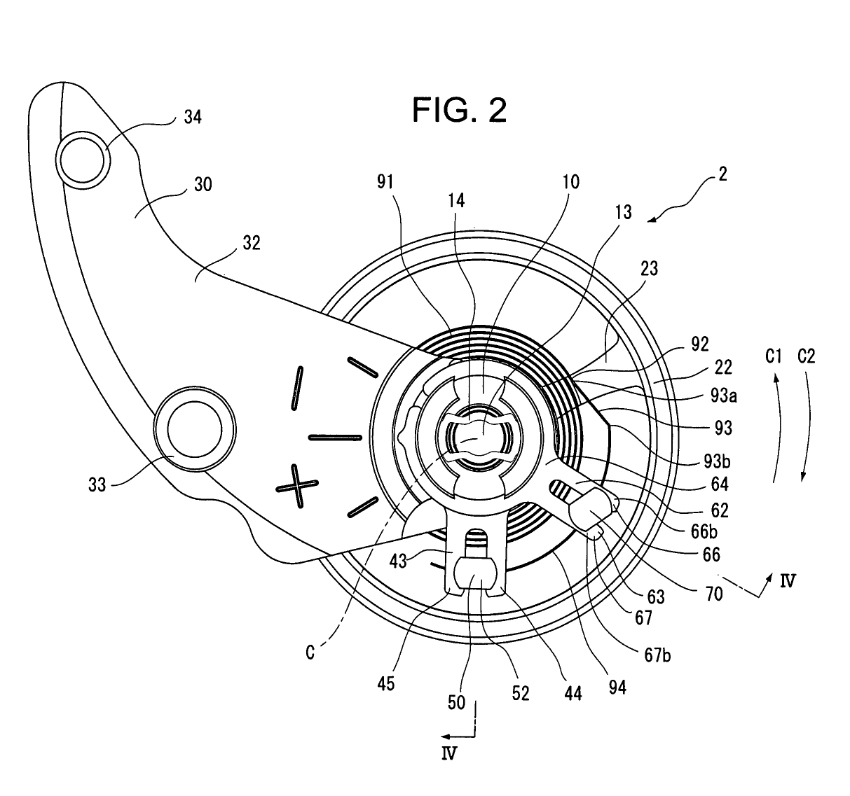

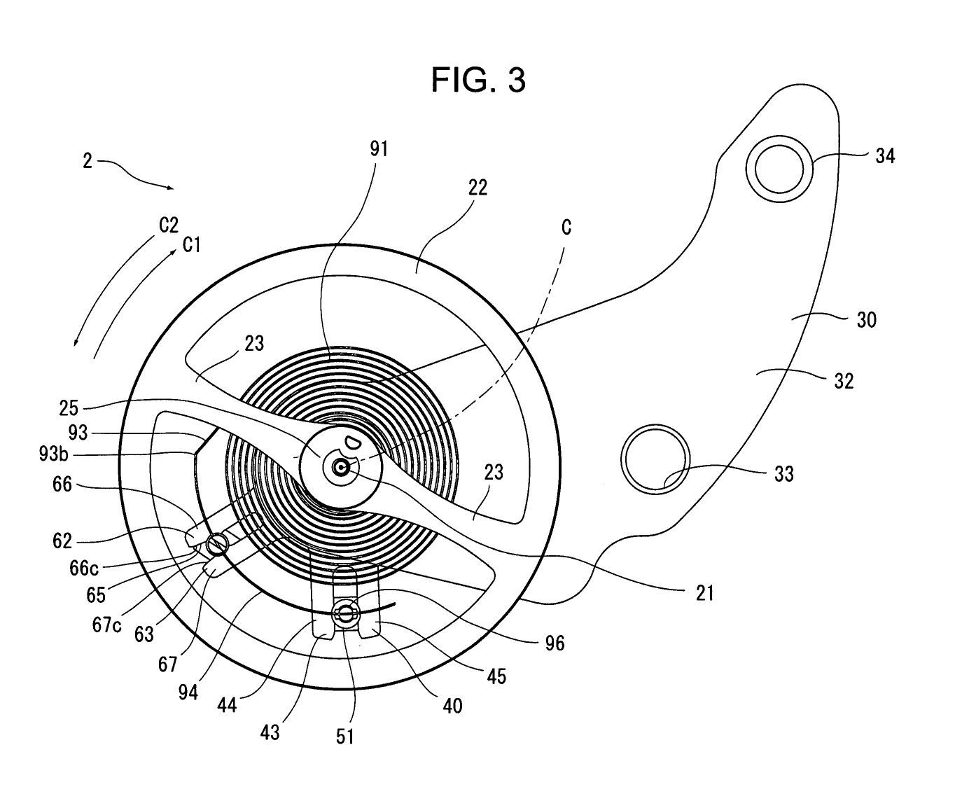

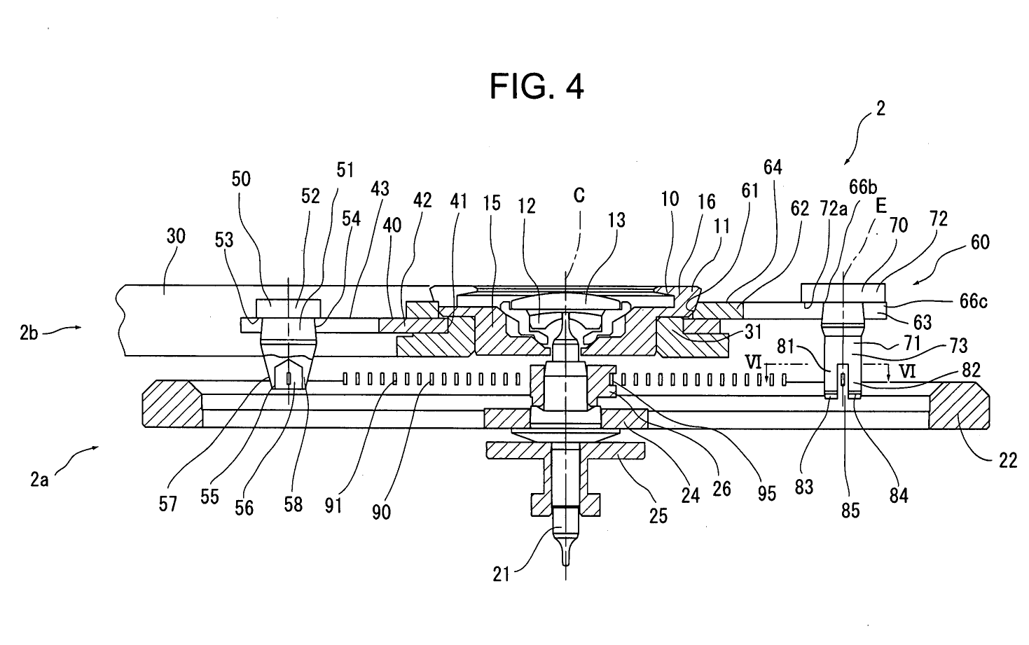

As shown in FIGS. 2 to 4, the structure of balance with hairspring 2 of the preferred example according to the invention has a balance staff 21 that is supported between an upper bearing for balance 10 and a lower bearing (not shown) of a main plate 6 (see FIG. 1) and is pivotable in C1 and C2 directions around the center axis C. The upper bearing for balance 10, in this case, as seen in FIG. 4 or 2, includes a bearing frame 11, an upper hole jewel 12 and an upper cap jewel 13, and a bearing support fastener 14. At the longitudinal center of the balance staff 21, a balance wheel 22 is fixed at an inner boss 24 of an arm 23. In FIG. 4, a double roller 25 that engages a body of pallet fork (not shown) of an escapement (not shown) is fixed on the lower end side of the balance staff 21, and a collet 26 is fixed on the upper end side of the balance staff 21. The bearing frame 11 of the upper bearing for balance 10 is fitted, at its reduced diameter portion 15, in a cylindrical portion 31 of a balance bridge 30. The balance bridge 30 is positioned and fixed on the main plate 6 at attachment portions 33 and 34 of an arcuate body 32. In this description including this paragraph, unless otherwise specified, the upward direction in FIG. 4 is referred to as “up” and the downward direction is referred to as “down”, only for convenience. Therefore, the case back (not shown) side of the timepiece 1 is referred to as “up” and the dial (not shown) side is referred to as down.

A stud support 40 fits in a base end hole 41 in the periphery of the cylindrical portion 31 of the balance bridge 30, and a stud 50 is attached to a front portion 43 of a radially extending body 42 of the stud support 40. In this example, the front portion 43 of the stud support 40, includes two-pronged arms 44 and 45, and a shaft 51 of the stud 50 is elastically fitted between the arms 44 and 45. In this example, the shaft 51 is shaped into a truncated cone, and an enlarged diameter flange 52 is formed on the reduced diameter end of the shaft 51. As an end surface 53 of the flange 52 and a truncated cone-like inclined surface 54 of the shaft 51 abut the arms 44 and 45, the stud 50 is positioned and held relative to the arms 44 and 45.

A regulator structure 60 is attached to the upper bearing for balance 10 such that the regulator structure 60 is pivotable in the C1 and C2 directions around the center axis C. The regulator structure 60 includes a body of regulator 62 that pivotably fits in abase end hole 61 in the periphery of a enlarged diameter portion 16 of the bearing frame 11 of the upper bearing for balance 10 and extends outward in the radial direction, and a regulator pin structure 70 that is attached to a front portion 63 of the body of regulator 62.

A hairspring 90 in the form of a spiral spring is disposed between the collet 26 and the stud 50. The hairspring 90 includes a uniformly spiraled body 91, a reformed portion 93 that follows the outer circumference end 92 of the body 91, and an arcuate outer end 94 that follows the outer circumference end of the reformed portion 93. In this example, although the reformed portion 93 is folded at its both ends 93a and 93b to form an inclined straight portion, it may be other shapes, for example, may be folded at three or more locations, as long as the outer end 94 can be apart from the body 91 in the radial direction. The hairspring 90 is fixed to the collet 26 at the radially inner end 95 of the body 91 and is also fixed, at the tip 96 of the outer end 94 that is situated beyond the reformed portion 93 along the outer circumferential direction, to a hairspring attachment portion 55 that is situated at the lower end of the stud 50. In this example, the hairspring attachment portion 55 is formed of two-pronged legs 57 and 58 with a gap 56 therebetween, and the tip 96 of the outer end 94 of the hairspring 90 is inserted in the gap 56 between the legs 57 and 58 and fixed at the inserted portion between the legs 57 and 58.

The structures of the upper bearing for balance 10, balance staff 21 balance wheel 22, double roller 25, collet 26, balance bridge 30, stud support 40 and stud 50, body of regulator 62, and hairspring 90 described above are by way of example only, and the shapes and structures thereof may be different from those illustrated as long as an alternative for each member can perform its essential function.

The body of regulator 62 of the regulator structure 60 includes a body 64 extending outward in the radial direction and two-pronged arms 66, 67 with a gap 65 therebetween on the front end side of the body 64.

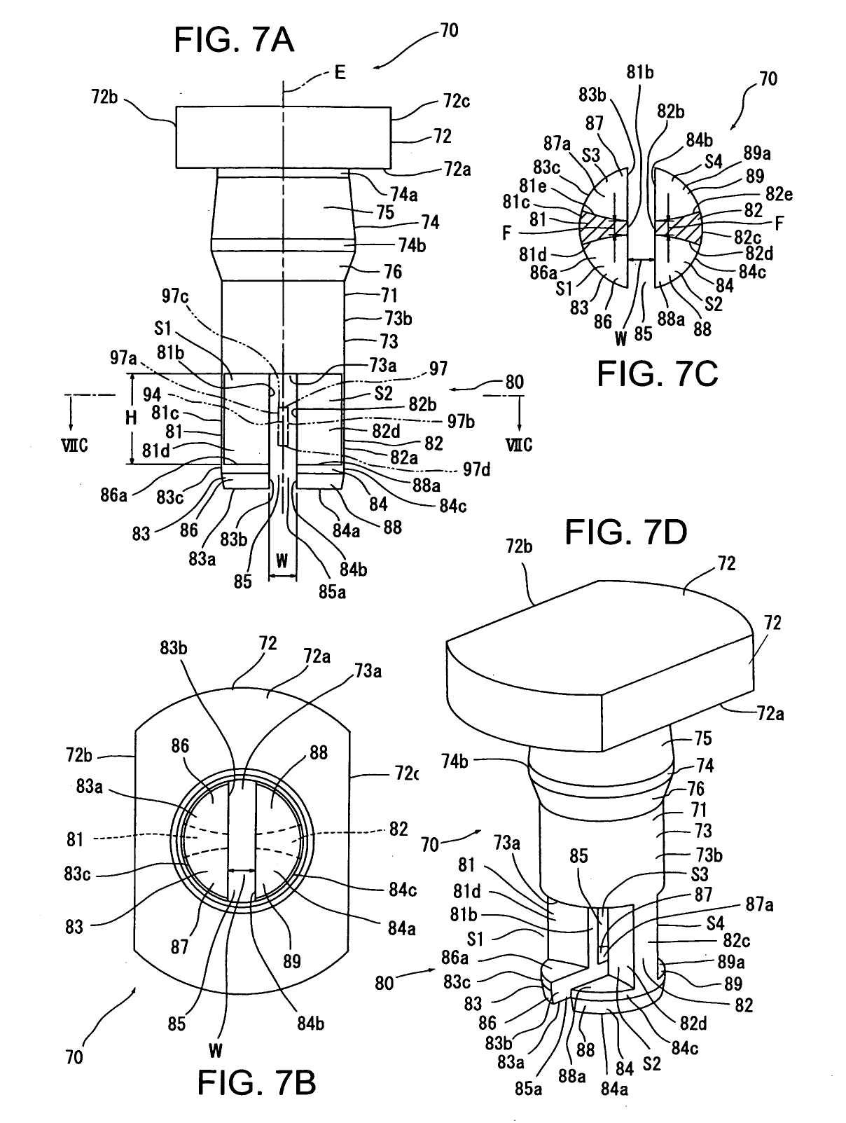

The regulator pin structure 70 includes a shaft 71, a head 72 on the base end side of the shaft 71, and a hairspring engagement portion 80 on the front end side of the shaft 71, as shown in FIGS. 7A to 7D.

The shaft 71 includes a cylindrical shaft body 73 as a pin-like body of the regulator pin structure 70, and a base 74 that connects the shaft body 73 to the head 71. The base 74 includes a base end-side truncated cone 75 with its reduced diameter end connected to a head 72 and an inverted shaft body-side truncated cone 76 with its enlarged diameter end connected to the enlarged diameter end of the base end-side truncated cone 75. A short cylindrical portion 74a is formed between the reduced diameter end of the base end-side truncated cone 75 and the head 72, and a short, enlarged diameter cylindrical portion 74b is formed between the enlarged diameter end of the base end-side truncated cone 75 and the enlarged diameter end of the shaft body-side truncated cone 76.

The head 72 is formed of a flange-like thick plate that projects outward in the radial direction and is sufficiently larger than the cylindrical portion 74a, and a principal plane 72a of the head 72 that faces toward the shaft 71 is a flat surface perpendicular to the center axis E of the regulator pin structure 70. The thick plate of the head 72 includes sides 72b and 72c parallel to each other.

The hairspring engagement portion 80 of the regulator pin structure 70 includes two-pronged legs 81, 82 and canopy-like projections 83, 84 that project laterally on both sides of the front portions of the legs 81, 82. A fixed-width gap or slit 85 is formed between the leg 81 with the canopy-like projection 83 and the leg 82 with the canopy-like projection 84. The gap 85 extends straight from front end-side principal planes 83a, 84a of the canopy-like projections 83, 84 to a front end-side end surface 73a of the shaft body 73 of the shaft 71. Therefore, the legs 81, 82 and canopy-like projections 83, 84 include flat walls or sides 81b, 82b and 83b, 84b that face toward the gap 85 and define-side walls of the gap 85. The sides 83b, 84b of the canopy-like projections 83, 84 are flush with the corresponding sides 81b, 82b of the legs 81, 82, respectively. Accordingly, the canopy-like projections 83, 84 extend laterally along the corresponding sides 81b, 82b of the legs 81, 82, respectively. In this example, with regard to the canopy-like projection 83 of the leg 81, “laterally” refers to a direction not only perpendicular to the center axis E of the regulator pin structure 70 but also substantially perpendicular to the direction toward the gap 85 from the leg 81 to the leg 82, and with regard to the canopy-like projection 84 of the leg 82, “laterally” refers to a direction not only perpendicular to the center axis E of the regulator pin structure 70 but also substantially perpendicular to the direction toward the gap 85 from the leg 82 to the leg 81.

The legs 81, 82 and the canopy-like projections 83, 84 include partial cylindrical circumferential surfaces 81c, 82c and partial cylindrical circumferential surfaces 83c, 84c that are extensions of the cylindrical circumferential surfaces 73b of the shaft body 73 of the shaft 71.

Each side of the legs 81, 82 is cut out into a partially cylindrical or arcuate shape, and the partially cylindrical concave or arcuate concave sides 81d, 82d of the leg 81, 82 and the partially cylindrical concave or arcuate concave sides 81e, 82e of the leg 81, 82 belong to the same respective cylindrical surfaces. Each of the sides 81b, 82b of the legs 81, 82 that face toward the gap 85 has a lateral width F (for example, approximately 0.05 mm or smaller) approximately equal to or smaller than the width W of the gap 85 (for example, approximately 0.1 mm or smaller). The width of the outer circumferential surfaces 81c, 82c of the legs 81, 82 are sufficiently larger than the width F of the side 81b, 82b such that the legs 81, 82 may-have sufficient mechanical strengths.

The canopy-like projection 83 of the leg 81 is formed of two lateral projecting portions 86, 87, and the canopy-like projection 84 of the leg 82 is also formed of two lateral projecting portions 88, 89. In this example, with regard to the projecting portions 86 to 89, “laterally” refers to,gas described above, a direction not only perpendicular to the direction in which the center axis E extends but also parallel to the direction in which the sides 81b, 82b of the gap or slit 85 extend.

Principal planes 86a, 87a, 88a and 89a of the projecting portions 86, 87, 88 and 89 that face toward the end surface 73a of the shaft body 73 are flush with each other.

The end surface 73a of the shaft body 73, the partial cylindrical side 81d of the leg 81, and the principal plane 86a of the projecting portion 86 of the canopy-like projection 83 form a substantially triangular, hairspring outer end accommodating column region S1. Similarly, the end surface 73a of the shaft body 73, the partial cylindrical side 82d of the leg 82, and the principal plane 88a of the projecting portion 88 of the canopy-like projection 84 form a substantially triangular, hairspring outer end accommodating column region S2, and the end surface 73a of the shaft body 73, the partial cylindrical side 81e of the leg 81, and the principal plane 87a of the projecting portion 87 of the canopy-like projection 83, form a substantially triangular, hairspring outer end accommodating column region S3, and the end surface 73a of the shaft body 73, the partial cylindrical side 82e of the leg 82, and the principal plane 89a of the projecting portion 89 of the canopy-like projection 84 form a substantially triangular, hairspring outer end accommodating column region S4. Each of the hairspring outer end accommodating regions S1, S2, S3 and S4 communicates with the gap or slit 85.

The hairspring outer end accommodating regions S1 and S2 can be simultaneously formed by a single cutting operation, such as arcuate wiper cutting. Similarly, the hairspring outer end accommodating regions S3 and S4 can also be simultaneously formed by arcuate wiper cutting. As this cutting operation can be incorporated as part of an automatic cutting process for forming the regulator pin structure 70, the regulator pin structure 70 can be manufactured by a series of continuous cutting operations. Therefore, the regulator pin structure 70 is structurally suitable for volume production.

As can be seen in FIG. 7A, the distance H between the principal planes 86a, 87a, 88a and 89a of the projecting portions 86, 87, 88 and 89 and the end surface 73a of the shaft body 73, in other words, the height H of the hairspring outer end accommodating regions S1, S2, S3 and S4 is sufficiently larger than the width of the hairspring 90 (the phantom lined portion in FIG. 7A).

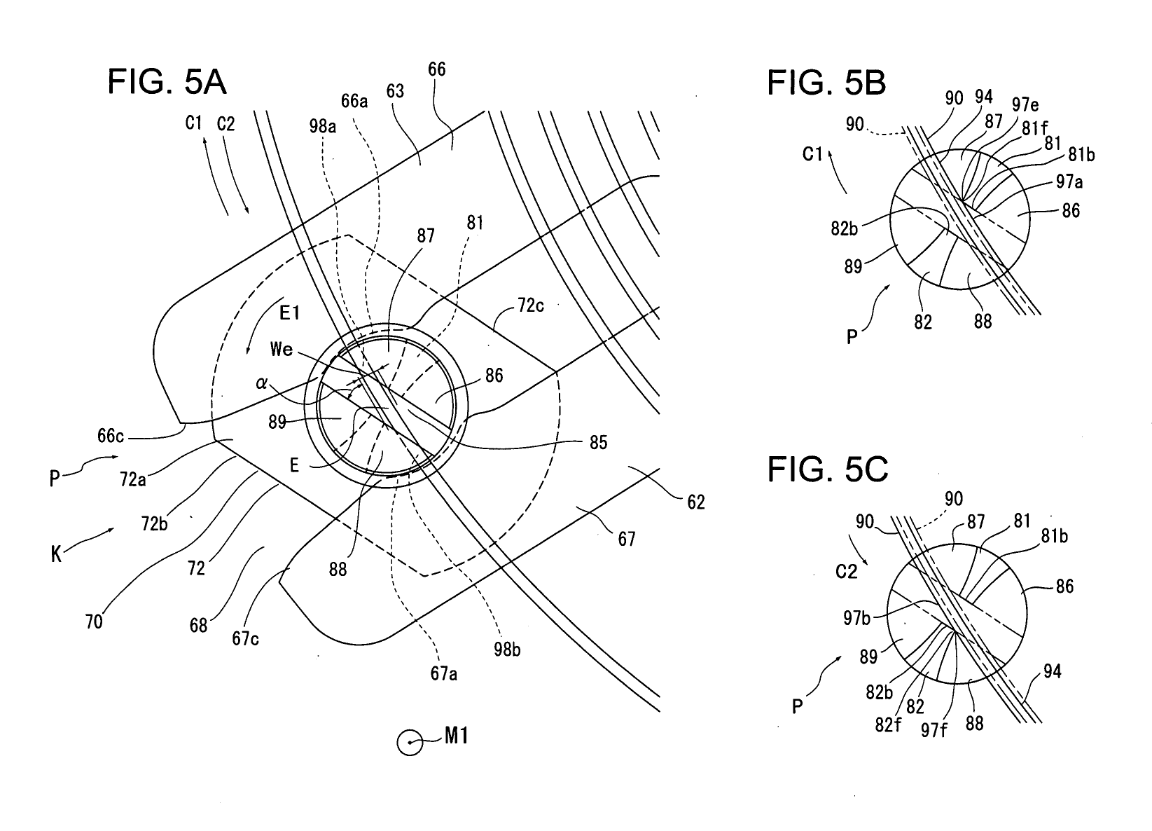

Thus configured regulator pin structure 70 is first attached to the body of regulator 62. In this attachment process, the regulator pin structure 70 is fixed to the body of regulator 62 in such a manner that the intermediate diameter cylindrical portion 74a of the base 74 of the shaft 71 and the reduced diameter portion of the truncated cone 75 are pushed in the K direction from an opening 68 between chamfered front edges 66c and 67c of the two-pronged arms 66, 67 at the front end 63 of the body of regulator 62 (see the tips of the body of regulator 62 in FIG. 5A, the enlarged view showing the assembled structure of balance with hairspring 2) and sandwiched between recesses 66a and 67a of the two-pronged arms 66 and 67. As the truncated cone 75 is elastically sandwiched, the surface 72a of the flange-like head 72 abuts surfaces 66b, 67b of the arms 66, 67 such that the regulator pin structure 70 is stably positioned. The regulator pin, structure 70 thus arranged is pivoted around the center axis E for positional adjustment such that an opening 85a of the slit 85 extends in the direction (circumferential direction of the upper bearing for balance 10) substantially perpendicular to the direction in which the body of regulator 62 extends (radial direction). The mounting procedure of the regulator pin structure 70 to the body of regulator 62 and their structures may be different from the above description as long as the regulator pin structure 70 is pivotable around the center axis E relative to the body of regulator 62. For example, the base of the regulator pin structure 70 may be mounted and fixed to the body of regulator 62 by means of a screw or the like.

Assembly of the structure of balance with hairspring 2 is carried out, for example, in the following procedure:

First, on one hand, the following parts of the structure of balance with hairspring 2 that are situated on the lower side, as shown in FIG. 4, are prepared as an lower assembly of the balance with hairspring 2a; the balance staff 21 and its associated attachments 25, 26 and the like, the balance wheel 22, the hairspring 90 and the stud 50. On the other hand, the following parts of the structure of balance with hairspring 2 that are situated on the upper side, as shown in FIG. 4, are prepared as an upper assembly of the balance with hairspring 2b; the upper bearing for balance 10, the balance bridge 30, the stud support 40, and the regulator structure 60.

Next, the upper assembly of the balance with hairspring 2b is inverted as opposed to that shown in FIG. 4 and placed on a base mount, on which the lower assembly of the balance with hairspring 2a is assembled. In this assembling process, for example, the upper tenon and the upper part of the shaft of the balance staff 21 are inserted in the mortise of the upper hole jewel 12 and the bearing hole of the bearing frame 11 of the upper bearing for balance 10 to support the balance staff 21 by the upper bearing for balance 10, and then the stud 50 is pushed inward in the radial direction from the enlarged opening between the arms 44 and 45 at the front portion 43 of the stud support 40 to assemble the stud 50 in the stud support 40. In this example, the way in which the stud 50 and the stud support 40 are coupled is the same as the above-mentioned way in which the regulator pin structure 70 and the body of regulator 62 are coupled. The way in which the upper assembly of the balance with hairspring 2b and the lower assembly of the balance with hairspring 2a are assembled maybe different from the above description. Also, the way in which the stud support 40 and the stud 50 are fixed and their structures may also be different from the above description.

Then, the tip 96 of the outer end 94 of the hairspring 90 is fixed to the stud 50, and an intermediate portion 97 of the outer end 94 of the hairspring 90 is picked up and freely inserted in the slit 85 of the regulator pin structure 70. As the size of the slit 85 of the regulator pin structure 70 is actually fixed down to the opening 85a (for example, about 0.1 mm) and is sufficiently larger than the thickness of the hairspring 90 (for example, about 0.03 mm), the outer end 94 of the hairspring 90 can freely fits in the slit 85 without difficulty. As the opening 85a of the slit 85 extends in the circumferential direction as described above, the outer end 94 extending in the same direction can freely fits in the slit 85 without any adjustment operation.

The upper assembly of the balance with hairspring 2b and the lower assembly of the balance with hairspring 2a are thus assembled to form the structure of balance with hairspring structure 2. The cross-sectional view of FIG. 4 exactly shows thus assembled structure of balance with hairspring structure 2.

In this initial state in which the hairspring 90 is freely fitted, as indicated by the phantom line in FIG. 7A, the portion 97 of the outer end 94 of the hairspring 90 is situated in the slit 85 of the regulator pin structure 70 with the inner circumference 97a of the portion 97 apart from the side 81b of the leg 81 of the regulator pin structure 70 and the outer circumference 97b apart from the side 82b of the leg 82, and the portion 97 freely fits in the gap 85 of the regulator pin structure 70 with one side edge 97c sufficiently apart from the end surface 73a of the shaft body 73 that corresponds to the bottom of the slit 85 and the other side edge 97d sufficiently apart from the principal planes 86a, 88a and the like of the projecting portions 86 to 89 that form the canopy-like projections 83, 84.

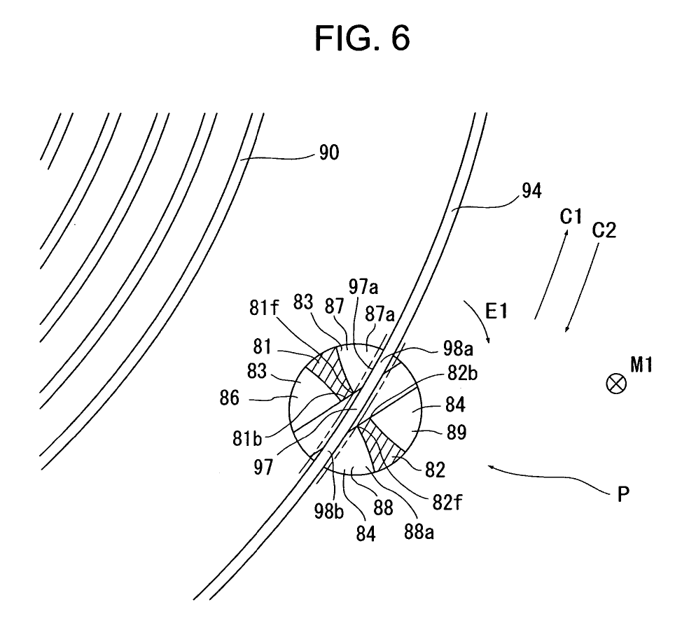

Next, as shown in FIGS. 5A and 6, by pivoting the regulator pin structure 70 around its center axis E (for example, in the El direction) relative to the body of regulator 62 by a desired angle a (see FIG. 5A) to adjust the effective width We of the slit 85 (see FIG. 5A), the tilt width of the hairspring 90 is adjusted. The effective width We used herein is the size of the slit or gap 85 when viewed in the direction substantially perpendicular to the direction in which the freely fitted portion 97 of the hairspring outer end 94 that freely fits in the slit 85 extends. The preformed cutout regions S3 and S2 allow the pivot movement by the angle a.

When the regulator pin structure 70 is in this pivotal position P and the balance wheel 22 pivots to a certain extent in the C1 direction to reduce the size of the spiral of the hairspring 90 to a certain extent, as indicated by the solid line shown in FIG. 5B, the inner surface 97a of the freely fitted portion 97 of the outer end 94 of the hairspring 90 abuts one side edge (inner side edge) 81f of the side 81b of the leg 81 of the regulator pin structure 70. In the movement to further reduce the size of the spiral, the portion 97e of the portion 97 of the outer end 94 of the hairspring 90 that abuts the side edge 81f serves as an outer fixed end of the spiral spring. On the other hand, when the regulator pin structure 70 is in this pivotal position and the balance wheel 22 pivots to a certain extent in the C2 direction to increase the size of the spiral of the hairspring 90 to a certain extent, as indicated by the solid line shown in FIG. 5C, the outer surface 97b of the freely fitted portion 97 of the outer end 94 of the hairspring 90 abuts the opposite side edge (outer side edge) 82f of the side 82b of the leg 82 of the regulator pin structure 70. In the movement to further increase the size of the spiral, the portion 97f of the portion 97 of the outer end 94 of the hairspring 90 that abuts the side edge 82f serves as an outer fixed end of the spiral spring. When the balance wheel 22 is in an intermediate pivotal position between the pivotal position in the C1 direction where the portion 97e of the outer end 94 of the hairspring 90 abuts the side edge 81f of the leg 81 of the regulator pin structure 70 and the pivotal position in the C2 direction where the portion 97f of the outer end 94 abuts the side edge 82f of the leg 82, the outer fixed end of the spiral spring, which is formed of the hairspring 90, is the portion 96 that is fixed to the stud 50. Therefore the cycle of the structure of balance with hairspring 2 depends on the length of time spent in the above three states. Typically, the magnitude of angle a is initially adjusted to basically set how the structure of balance with hairspring 2 moves.

In the pivotal position P, as seen in FIGS. 5A and 6, portions 98a and 98b that are on both sides of and in proximity to the freely fitted portion 97 of the outer end 94 of the hairspring 90 pass through the regions S3 and S2, respectively, and when viewed in the plan views, overlap with the projecting portions 87 and 88 of the canopy-like projections 83 and 84 that project laterally from the legs 81 and.82. Therefore, even if the outer end 94 of the hairspring 90 is displaced due to a shock or the like in the M1 direction in which it is released from the opening 85a of the slit 85, the lower edge 97d of the freely fitted portion 97 or its adjacent portions 98a , 98b of the hairspring 90 hit the surfaces 87a, 88a of the projecting portions 87, 88 of the canopy-like projections 83, 84, thereby preventing the freely fitted portion 97 of the outer end 94 from being released from the slit 85.

As described above, in the structure of balance with hairspring 2, on one hand, since the size W of the gap 85 of the regulator pin structure 70 is sufficiently larger than the thickness of the hairspring 90, in the initial state (before the pivotal movement) in which the gap 85 of the regulator pin structure 70 extends substantially parallel to the portion 97 of the outer end 94 of the hairspring 90 along the circumferential direction, the hairspring 90 can freely fits in the gap 85 of the regulator pin structure 70 without difficulty. Also, in the structure of balance with hairspring 2, since the regulator pin structure 70 has the canopy-like projections 83, 84 that project laterally from the legs 81, 82, simply by pivoting the regulator pin structure 70 around the center axis E into the predetermined pivotal position P where the effective width We of the slit 85 of the regulator pin structure 70 becomes a predetermined level, the canopy-like projections 86 and 88 can effectively prevent the hairspring 90 from being released from the slit 85 of the regulator pin structure 70. More or less variations of the adjustment angle a will not impair the capability of the canopy-like projections 86, 88 to prevent from the portion 97 of the outer end 94 being released from the slit 85, as long as the pivotal angle a is set to a certain magnitude or greater.

As seen in FIG. 7A, since the edge 97d of the hairspring 90 is apart from the principal planes 87a, 88a, the pivotal movement in the E1 direction still keeps the edge 90b apart from the principal planes 87a and 88a in the normal operation and the canopy-like projections 83 and 84 will not interfere with the motion of the hairspring 90.

When thus configured structure of balance with hairspring 2 is assembled as part of the timepiece 1, adjustment of the operation rate of the timepiece is carried out in a regular manner, for example, by adjusting the pivotal position of the body of regulator 62 around the central axis C.

The canopy-like projections may be any shapes and structures as long as they do not effectively project in a direction in which the width W of the slit or gap 85 is reduced but they allow easy insertion of the outer end 94 of the hairspring 90 into the slit 85, and also they laterally project by a sufficient length such that the pivotal movement of the regulator pin construction 70 around the central axis E to the predetermined pivotal position P (adjustment of the effective width We of the slit 85 to a predetermined size) can effectively prevent the freely fitted portion 97 from being released from the opening of the slit 85 on the rear side (the opening side of the slit) of the adjacent portions 98a, 98b of the freely fitted portion 97 of the outer end 94. However, of course, the canopy-like projections should be accompanied with outer end accommodating regions such as S1 to S4.

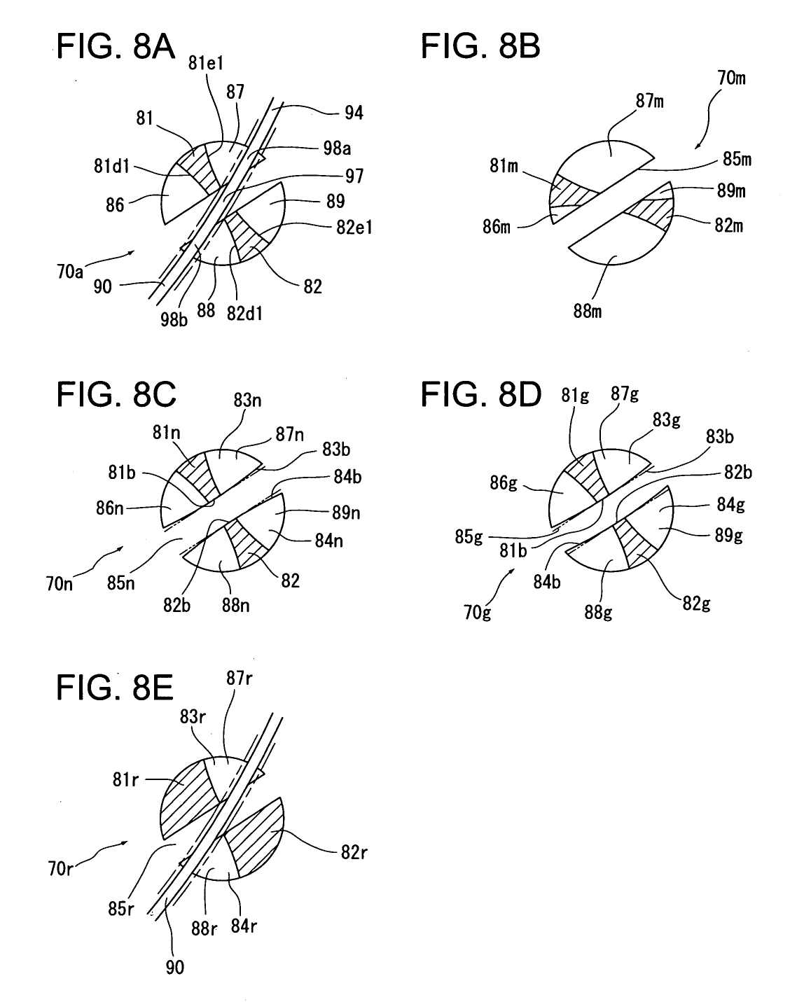

For example, in a regulator pin structure 70a, for the sides of the legs 81, 82, the above partial cylindrical surfaces may be replaced with flat surfaces, as indicated by symbols 81d1, 81e1, 82d1 and 82e1 shown in FIG. 8A, or other shapes. In this case, again, the legs 81, 82 are shaped such that the widths of the sides 81b, 82b that face toward the slit 85 can be as small as possible while the legs 81, 82 maintain their strengths, that is, the closer to the slit 85, the smaller the widths of the legs 81, 82. In this example, main portions or elements with changes are indicated by symbols with an index of 1 appended.

The projecting portions of the canopy-like projections 83, 84 symmetrically formed on both sides of the legs 81, 82 may be replaced with those asymmetrically formed on both sides of legs 81m, 82m, as shown in FIG. 8B. In this figure, when a regulator pin structure 70m is set at the pivotal position P, a slit 85m extend diagonally such that projecting portions 87m, 88mof the canopy-like projections 83, 84 that overlap with the portions 98a, 98b adjacent to the freely fitted portion 97 of the outer end 94 of the hairspring 90 are larger than the other projecting portions 86m, 89m. In this example, main portions or elements with changes are indicated by symbols with an index of m appended.

The straight (flat) sides that form the slit may also be replaced with curved (rounded) sides. For example, in an exemplary regulator pin structure 70n shown in FIG. 8C, slit-defining sides 83b, 84b of canopy-like projections 83n, 84n, are convexly curved, and the sides 81b, 82b of the legs along the sides 83b, 84b are also convexly curved. In this case, the slit-defining sides 83b, 84b of the canopy-like projections 83, 84 are slightly more recessed than the leg-defining sides 81b, 82b, and the degree of recess and recessed shape may be different as long as the laterally projected canopy-like projections 83n, 84n prevent the freely fitted portion 97 of the outer end 94 of the hairspring 90 from being released from a slit 85n by preventing the portions 98a, 98b adjacent to the freely fitted portion 97 from being moved in the release direction. In this example, main portions or elements with changes are indicated by symbols with an index of n appended.

For example, as shown in FIG. 8D, in a regulator pin structure 70q, one of the slit-defining sides 83b, 84b of canopy-like projections 83g, 84g may be convexly curved and the other may be concavely curved such that they follow the curvature of the outer end 94 of the hairspring 90. In this case, the sides 81b, 82b of the legs along the sides 83g, 84g are also convexly and concavely curved, respectively. In this example, main portions or elements with changes are indicated by symbols with an index of g appended.

Furthermore, if desired, the cutout for forming a canopy-like projection may be omitted on the side where the projection is not required. For example, in the examples shown in FIGS. 5A to C and 6, the projecting portions 86, 89 may be omitted from an operation point of view. Therefore, for example, in a regulator pin structure 70r shown in FIG. 8E, canopy-like projections 83r, 84r may be formed of one projecting portion 87r, 88r, respectively. In this case, for example, each of legs 81r, 82r may have a substantially fan-shaped cross section with a center angel of about 90 degrees. In this example, main portions or elements with changes are indicated by symbols with an index of r appended. * From this point of view, for example, the projecting portions 86, 86m, 86n and 86g and projecting portions 89, 89m, 89n and 89g in the examples shown in FIGS. 8A, 8B, 8C and 8D may be omitted. In this case, regions corresponding to the projecting portions 86, 86m, 86n and 86g and projecting portions 89, 89m, 89n and 89g may be, for example, cut out along the sides of the legs 81, 81m, 81n and 81g and legs 82, 82m, 82n and 82g down to the tips of the legs.

However, the formation of canopy-like projections on both sides of the legs 81, 82 is advantageous in that the regulator pin structure can be rotated in either direction around the center axis E.

Although the above description is based on the example in which the regulator pin structure 70 is pivoted clockwise by the angle a, if desired, the regulator pin structure 70 may be pivoted counterclockwise by a desired angle (for example, the angle a). In this case, as relevant projecting portions of the canopy-like projections 83, 84 are the portions 86, 89 instead of the portions 87, 88, the descriptions about the portions 87, 88 in the above variations should be regarded as those about the portions 86, 89.

Although the surfaces 87a, 88a and the like (see FIG. 6) of the canopy-like projections 83, 84 that face toward the side edge 90b of the hairspring 90 are typically flat surfaces parallel to the plane in which the hairspring 90 extends, the surfaces 87a, 88a may be inclined or have recesses and/or projections as long as the surfaces 87a, 88a are situated apart from the side edge 90b of the hairspring 90 such that they will not interfere with the motion of the hairspring 90. That is, details of the surfaces 87a, 88a and the like may be selected as desired as long as the height H of the hairspring outer end accommodating regions S1 to S4 is sufficiently larger than the width of the hairspring 90.

Similarly, although the end surface 73a of the shaft body 73 is also typically a flat surface parallel to the plane in which the hairspring 90 extends, the end surface 73a may be inclined or have recesses and/or projections as long as the end surface 73a is situated apart from the side edge 90b of the hairspring 90 such that it will not interfere with the motion of the hairspring 90.

Although, with regard to the end surface of the shaft body 73, in the illustrated example, the portion in the gap or slit 85 and the portions in the hairspring outer end accommodating regions S1 to S4 are flush with each other (at the same level), if desired, the portion in the slit 85 may project more toward the front side of the legs 81, 82.

Regarding the sides 81b, 82b of the legs 81, 82 that face toward the gap or slit 85, since one of the side edges of the side 81b and one of the side edges of the side 82b define the effective width We, the corners of those effective width-defining side edges may be rounded.

What is claimed is:

1. A regulator pin structure comprising:
a pin-like body;
a base that is situated on one end of the body and mounted to a body of regulator such that the position of the base is adjustable around the pivotal center axis of the body; and
a pair of two-pronged legs that extend from the other end of the body,
wherein part of the outer end of a hairspring that is situated beyond a reformed portion of the hairspring along the outer circumference direction is freely fitted in a gap between the pair of legs; and
a canopy-like projection is formed on at least one side edge of the front portion of at least one of the pair of legs in such a manner that the canopy-like projection laterally projects along a side of the at least one leg that faces toward the gap.

2. A regulator pin structure according to claim 1, wherein a side edge of at least one of the pair of legs is cut out and shaped such,that the at least one leg has a thinner shape at a location closer to the other one of the pair of legs.

3. A regulator pin structure according to claim 2, wherein the edge of the projecting portion of the canopy-like projection is an extension of the outer circumferential surface of the body.

4. A regulator pin structure according to claim 1, wherein a side of the canopy-like projection of the at least one leg, the side being situated along the side of the at least one leg, is flush with the side of the at least one leg.

5. A regulator pin structure according to claim 1, wherein the canopy-like projection is formed on both side edges of the front portions of the both legs.

6. A regulator pin structure according to claim 1, wherein the canopy-like projection is formed at both side edges of the front portions of the both-legs, and a side of each of the canopy-like projections of each of the legs, the side being situated along the side of the leg, is flush with the side of the leg.

7. A regulator pin structure according to claim 1, wherein the canopy-like projection is formed by wiper cutting of the leg.

8. A regulator comprising:
a body of regulator with a mounting hole for a regulator pin structure; and
the regulator pin structure according to claim 1 with a base mounted in the mounting hole of the body of regulator.

9. A structure of balance with hairspring comprising the regulator according to claim 8.

10. A mechanical timepiece comprising the structure of balance with hairspring according to claim 9.
